(19) United States
(12) Patent Application Publication
(10) Pub. No.: US 2021/0345101 A1
(43) Pub. Date: Nov. 4, 2021

(54) LiFi Location Services as a Prerequisite to System Activation

(71) Applicant: International Business Machines Corporation, Armonk, NY (US)

(72) Inventors: Stanley Bryan Hardter, Baldwinsville, NY (US); HuyAnh Dinh Ngo, Sterling Heights, MI (US); Seng Chai Gan, Ashburn, VA (US); Adam Lee Griffin, Dubuque, IA (US)

(21) Appl. No.: 16/861,875

(22) Filed: Apr. 29, 2020

(51) Int. Cl. H04W 12/00; H04W 12/06; H04L 9/32; H04B 10/112; H04W 64/00

(52) U.S. Cl. CPC H04W 12/00503; H04W 12/0609; H04W 64/00; H04B 10/112; H04L 9/3263

(57) ABSTRACT

An approach is disclosed that receives location data from a location based device via a Light Fidelity (LiFi) wireless communication adapter. A LiFi receiver at the receiving system is within a direct line-of-sight to a LiFi transmitter of the location based device. The received location data is then provided to a bootable network asset, such as a virtual machine (VM) or application container running on the system. The bootable network asset then determines whether to operate based on the received location data.

### BACKGROUND

Intellectual property in the form of programs, data, and the like increasingly reside on “the cloud” in the form of virtual machines (VMs), and application containers rather than as software running on traditional computer systems. Because of such virtualization, it is not often clear where a virtualized system is running geographically. While an organization believes it is running at a data center at a known location, the virtualized system may have been moved to a different data center, or individual computer system, residing in a completely different location. While some movement may be for legitimate reasons, such as a first data center becoming overwhelmed and needing to offload work to a different data center, other movement may be due to malevolent activities performed by rogue actor, such as a hacker, that is attempting to steal an organization's intellectual property.

### SUMMARY

An approach is disclosed that receives location data from a location based device via a Light Fidelity (LiFi) wireless communication adapter. A LiFi receiver at the receiving system is within a direct line-of-sight to a LiFi transmitter of the location based device. The received location data is then provided to a bootable network asset, such as a virtual machine (VM) or application container running on the system. The bootable network asset then determines whether to operate based on the received location data.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting components used in a system that uses LiFi location services as a prerequisite to system activation;

FIG. 4 is a flowchart depicting both initialization by the location based device, such as in a data center, as well as the device's communications over LiFi to other systems;

FIG. 5 is a flowchart depicting steps taken by systems, such as rack mounted systems in a data center, communicating over a LiFi network to receive current geographic location data of the system; and

FIG. 6 is a flowchart depicting steps taken by a bootable network asset, such as physical systems, virtual machines (VMs), and application containers, to determine whether to boot based on current geographic information received from the system in which the bootable network asset is running.

### DETAILED DESCRIPTION

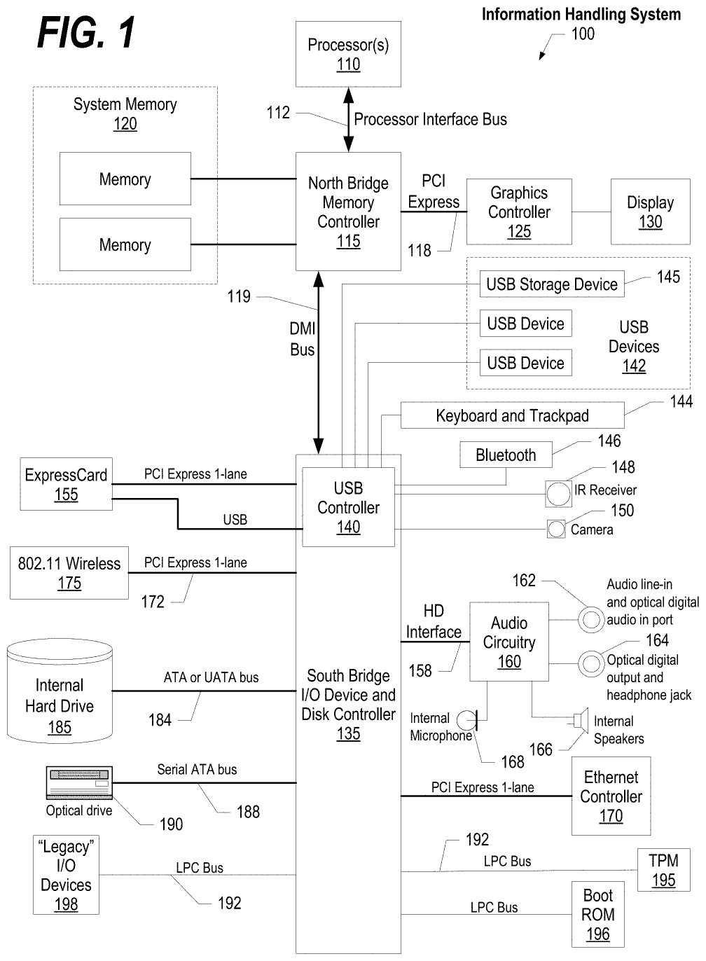

FIGS. 1-6 show an approach that uses a LiFi (Light Fidelity) network to communicate between systems in a line-of-sight manner to provide assurance that software is running in an authorized geographic location. LiFi is a wireless communication technology that utilizes light, generally from LED lamps, to transmit data and position between devices. LiFi transmitters at a known location, such as a data center, transmit location information to systems, such as rack mounted systems in the data center, informing the systems of their current location. Because the data center device communicates of LiFi, the proximity of the systems is confirmed as being within a line-of-site to the data center device. In one embodiment, the data center device has transmitters and receivers located in the ceiling or other area where line-of-sight to the systems in the data center can be achieved, such as by locating the systems' LiFi transmitters and receivers on the top of the rack mounted systems so that a clear line-of-sight is available between the systems' LiFi transmitters and receivers and the data center device's LiFi transmitters and receivers with which they communicate. Once the systems' geographic location is ascertained, this information can be made available to bootable network assets, such as physical systems, virtual machines (VMs), and application containers, running in the systems. Bootable network assets can then use the location information, such as in a pre-boot sequence, to inhibit booting and access of the bootable network asset from an unknown or undesired geographic location.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

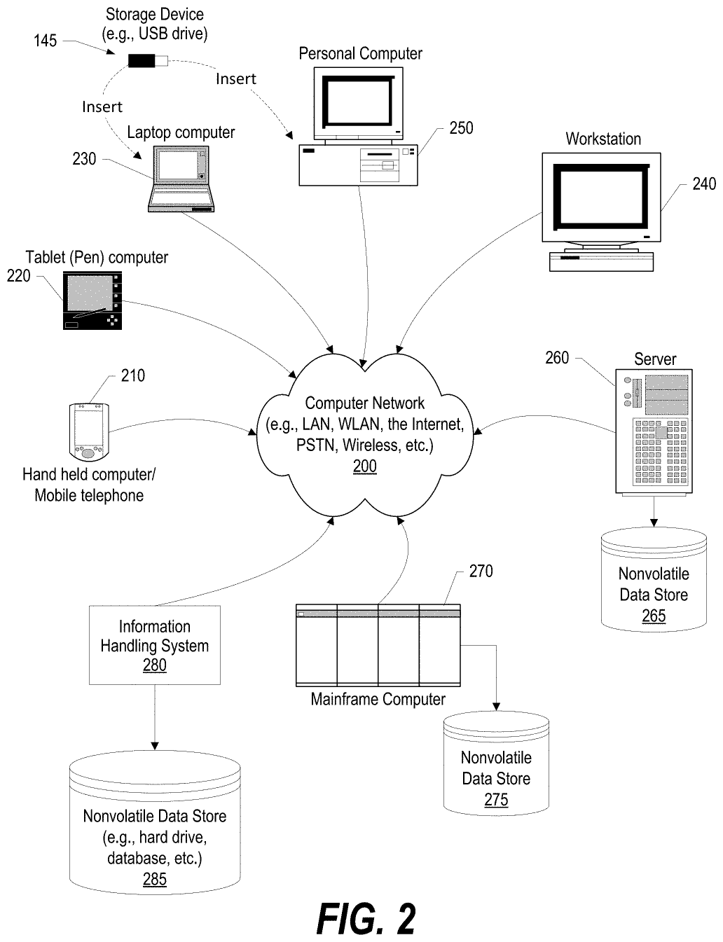

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

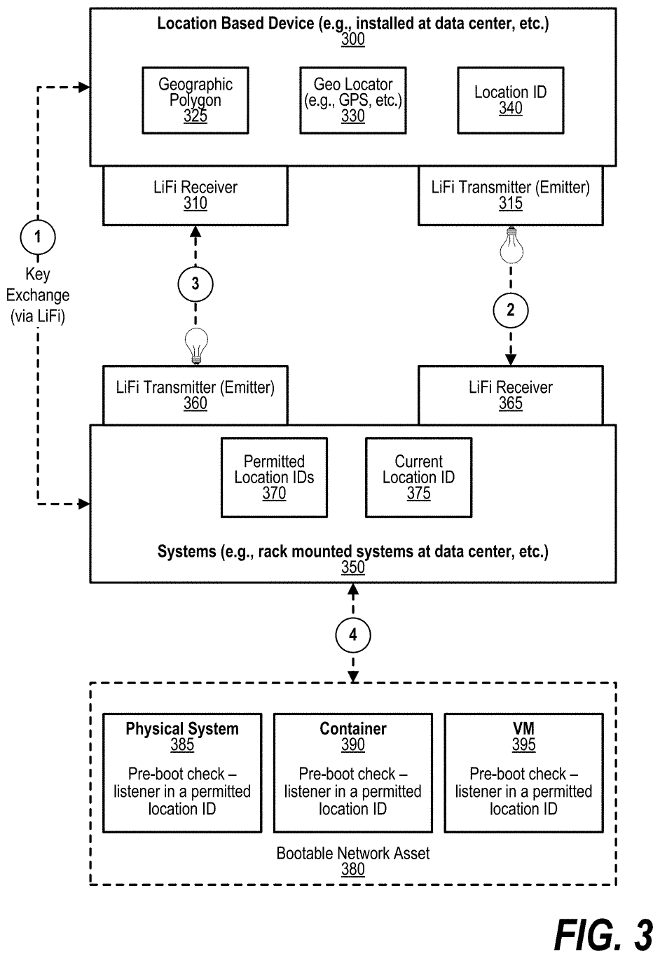

FIG. 3 is a component diagram depicting components used in a system that uses LiFi location services as a prerequisite to system activation. Location based device 300, such as a system installed at a data center, has components that allow it to communicate its location to other devices over a LiFi adapter that includes LiFi receiver 310 and LiFi transmitter (emitter) 315. In addition, location based device 300 include data stores 325, 330, and 340. Data store 325 is one or more geographic locations, such as geographic polygons, that define a geographic area (polygon) where the location based device is supposed to be operating. As used herein, a geographic polygon can be an area or set of related areas, such as one geographic identifier that includes a north-side datacenter and a south-side datacenter where both datacenters are in the same city. For example, a geographic polygon might define an area, or areas, such as one or more data centers near a particular city in a particular country, such as a data center in Buffalo, N.Y. in the United States.

Geographic locator 330 is data from a device that provides the current geographic whereabouts of the location based device. One example of a geographic location is a Global Positioning System (GPS) receiver that receives global positioning data from orbiting satellites. A comparison of geographic polygon(s) 325 with current geo location data 330 reveals whether the location based device is operating at a designated (e.g., approved, etc.) location, such as the aforementioned datacenter in Buffalo, N.Y. A set of location identifiers can be assigned to the one or more geographic polygon with device 300 storing the current geographic identifier in data store 340. For example, the polygons stored in data store 325 might define the datacenter in Buffalo, N.Y. as well as an alternate polygons defining datacenter locations in Indianapolis, Ind. and Wuhan, China. Identifiers (e.g., BNY for Buffalo, IIN for Indianapolis, and WCH for Wuhan, etc.) can be associated as location identifiers of the corresponding polygons. When geographic locator 330 retrieves data indicating that device 330 is at the predefined Buffalo location, the “BNY” identifier is stored in data store 340. Likewise, when geographic locator 330 retrieves data indicating that device 330 is at the predefined Indianapolis location, the “IIN” identifier is stored in data store 340, and when the locator retrieves data indicating that device 330 is at the predefined Wuhan location, the “WCH” identifier is stored in data store 340. However, when geographic locator 330 retrieves data indicating that device 330 is not at any of the predefined locations defined by geographic polygons 325, then an error condition exists and a proper location identifier is not stored in data store 340. In one embodiment, an error is noted as the geographic identifier (e.g., with the location ID being “error,” “unknown,” etc.).

Systems 350 at the location (e.g., data center, etc.) where location based device 300 communicate with device 300 using their own LiFi adapters that include LiFi receiver 360 and LiFi transmitter (emitter) 365 used to wirelessly communicate with device 300 using LiFi which assures that device 300 is within line-of-sight of systems 350. Systems 350 (e.g., rack mounted server systems, etc.) have LiFi adapters installed in such a way so that LiFi transmitter 360 and LiFi receiver 365 have a clear line-of-sight to the LiFi receiver(s) 310 and transmitter(s) 315. In one embodiment, the systems' LiFi transmitters 360 and receivers 365 are installed facing a ceiling of the location with device 300's corresponding receiver(s) 310 and transmitter(s) 315 being installed above, such as ceiling mounted components, allowing a clear line of sight between the receivers and transmitters. As further described below, systems 350 receive location data from device 300 using the systems' LiFi wireless communication adapter(s). Systems 370 may have a list of one or more pre-approved, or permitted, location identifiers stored in data store 370 accessible by the system as well as the current location identifier where device 300 is currently operating that is stored in data store 375, which is also in a storage area accessible by the system. Using the example from above, the system may have permitted location identifiers of BNY and IIN indicating that the Buffalo, N.Y. location and the Indianapolis, Ind. location are permitted location, however the Wuhan, China location (“WCH”) is not listed as a permitted location identifier for this system (e.g., due to import-export laws, regulations, etc.). The current identifier from device 300 is stored in 375.

Systems 350 have one or more bootable network assets 380 installed. These bootable network assets can include physical information handling systems 385 (e.g., a system installed in a rack mounted system, etc.), application container 390 running on one of the systems included in systems 350, and Virtual Machine (VM) 395 also running on one of the systems included in systems 350. Location data retrieved by systems 350 from device 300 is provided to these bootable network assets that can then determine whether to operate based on where the system running the bootable network asset is currently residing.

In one embodiment, systems 350 provide location data to the bootable network asset with the location data including the current location identifier (data store 375) as well as an indicator as to whether the current location identifier is included in the systems' list of permitted location identifiers. Using the example data from above where Wuhan, China was not included in the list of permitted locations, when the device indicates it is in the Wuhan, China location, then system 350 would inform bootable network assets that the system is in an “unlisted” location indicating that the system is currently in a location that is not included in the list of permitted location identifiers from data store 370. However, if the system is in either Buffalo or Indianapolis, then the system informs the bootable network assets that the system is in a “listed” location indicating that the system is currently in a location that is included in the list of permitted location identifiers. Furthermore, if the location is in an area not recognized by device 300, or if LiFi communication between systems 350 and device 300 is thwarted or otherwise fails, then systems 350 informs the bootable network assets that the system is in an “unknown” location that should not be trusted.

In one embodiment, bootable network assets 380 can use a pre-boot sequence to receive location data from systems 350 and determine whether to operate based on the received location data. Bootable network assets can utilize permitted locations as ascertained by systems 350 or can independently determine particular locations where the asset should operate. Using the example from above, a bootable network asset might receive a notification from systems 350 that the system is in an “unknown” location and, if location security is being implemented, the bootable network asset should inhibit further operations. If the location is noted as “listed” with the location being Buffalo, then the bootable network asset can either be configured to operate at any “listed” location or can further evaluate whether to operate at a listed location (e.g., only operate in Indianapolis, not in Buffalo, etc.). If the location is noted as “unlisted,” then the bootable network asset can be configured to inhibit further operations because the location is unlisted or can further evaluate the location to deem whether location should be allowed. For example, using the Wuhan, China example from above, if the bootable network asset is authorized to run in Wuhan without violating any applicable rules and regulations, then the bootable network asset can be configured to run in Wuhan (location identifier “WCH”) even though “WCH” is not included in systems' 350 list of permitted locations 370 and the “WCH” location identifier was noted as being “unlisted” in the location data provided by systems 350.

The circled numbers in the diagram shown in FIG. 3 indicate an order of steps, some of which having been somewhat described above. In step 1, device 300 and systems 350 exchange, via LiFi communications, certificate keys with one another (e.g., using X.509 protocols, etc.) to verify the identity of the other party. If the key exchange is successful, then, at step 2, device 300 sends its current location data to systems 350 (e.g., location identifier or “unknown” if not at a known location, etc.). At step 3, systems compare its permitted location identifiers with the location identifier provided by device 300 and enters a state to provide location data to bootable network assets. At step 4, the bootable network asset receives such location data, as described above, from system 350 where the bootable network asset is currently running. Based on the location data provided to the bootable network asset by systems 350, the bootable network asset determines whether to continue operations (e.g., at an approved geographic location, etc.) or to inhibit further operations (e.g., at a non-approved geographic location or at an “unknown” location, etc.).

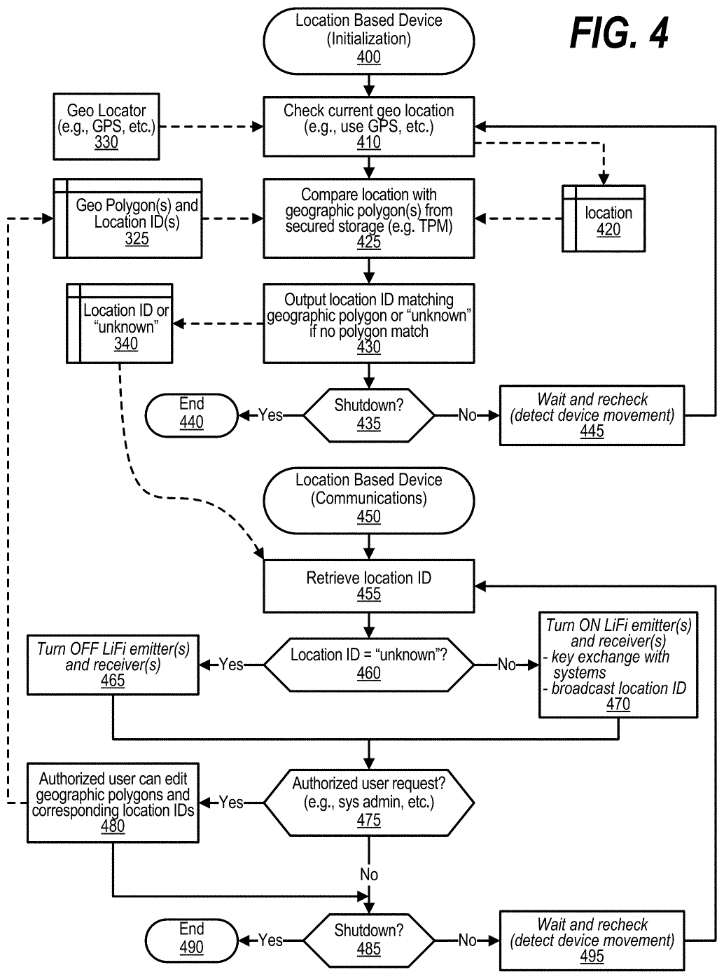

FIG. 4 is a flowchart depicting both initialization by the location based device, such as in a data center, as well as the device's communications over LiFi to other systems. FIG. 4 processing commences at 400 where an initialization process that is performed by a location based device is shown. At step 410, the process checks for the device's current geographic location from geographic locator 330, such as from a GPS receiver. The location data received from the geographic locator device is stored in memory area 420.

At step 425, the process compares the device's current geographic location with one or more geographic polygons that are retrieved from secured storage area 325, such as from a memory area within a Trusted Platform Module (TPM) or other type of secured memory. At step 430, the process outputs the location identifier that matches one of the defined geographic polygon to memory area 340. If the current location does not fall within one of the defined geographic polygons, then an error (e.g., “unknown,” etc.) is written to memory area 340.

The process determines as to whether the device is being shutdown (decision 435). If the device is being shutdown, then decision 435 branches to the ‘yes’ branch whereupon processing ends at 440. On the other hand, if the device is not being shutdown, then decision 435 branches to the ‘no’ branch whereupon, at step 445, the process waits for a period of time (e.g., one minute, etc.) and rechecks the device's current geographic location as described above. The initialization process is repeatedly performed in order to detect any movement of the device to a different geographic location.

At 450 a communication process that is performed by a location based device is shown. At step 455, the process retrieves the device's location identifier from memory area 340 with the location identifier being stored by the initialization routine described above. The process determines as to whether the location identifier is “unknown,” indicating that the location identifier does not match any defined geographic polygons established for the device (decision 460).

If the location identifier is “unknown,” then decision 460 branches to the ‘yes’ branch whereupon, at step 465, the process turns OFF all of the device's LiFi emitters and receivers inhibiting any communications between the device and systems supported by the device (e.g., systems running in the data center where the device is installed, etc.). On the other hand, if the location identifier is not “unknown” but is a location identifier, then decision 460 branches to the ‘no’ branch whereupon, at step 470, the process turns ON the device's LiFi emitters and receivers allowing key exchange with systems supported by the device as well as the broadcasting of the location identifiers to such systems.

The process determines as to whether an authorized user request has been received (decision 475). If an authorized user request has been received, then decision 475 branches to the ‘yes’ branch whereupon, at step 480, the process allows such authorized user to edit the geographic polygons and corresponding location identifiers that are stored in secured memory 325. On the other hand, if an authorized user request has not been received, then decision 475 branches to the ‘no’ branch bypassing step 480.

The process determines as to whether the device is being shutdown (decision 485). If the device is being shutdown, then decision 485 branches to the ‘yes’ branch whereupon processing ends at 490. On the other hand, if the device is not being shutdown, then decision 485 branches to the ‘no’ branch whereupon, at step 495, the process waits for a period of time (e.g., one minute, etc.) and rechecks the device's communication status as described above. The communication process is repeatedly perform in order to detect any movement of the device to a different geographic location that would change the communication status by either turning on or off the device's LiFi emitters and receivers.

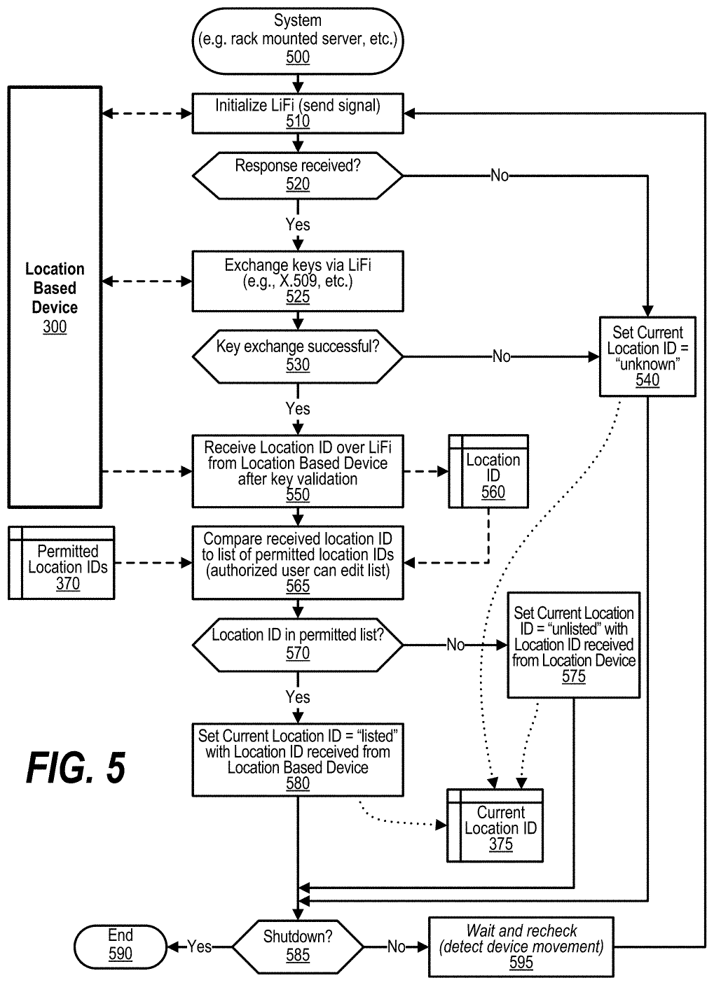

FIG. 5 is a flowchart depicting steps taken by systems, such as rack mounted systems in a data center, communicating over a LiFi network to receive current geographic location data of the system. FIG. 5 processing commences at 500 and shows the steps taken by a process performed by a system running one or more bootable network assets. For example, the system might be a rack mounted server with the bootable network assets being virtual machines, application containers, and physical information handling systems running in the system. This process allows the system to retrieve information about the system's current geographic location so that such information can be provided to such bootable network assets upon request.

At step 510, the process initializes LiFi communications, such as by sending a LiFi signal over a LiFi emitter (transmitter) intended for receipt by a location based device. The process determines whether a response was received (decision 520). If a response was received, then decision 520 branches to the ‘yes’ branch to communicate with the location based device. On the other hand, if no response was received, then decision 520 branches to the ‘no’ branch whereupon, at step 540, the system's current location identifier is set to “unknown” in memory area 375. When a response was received then, at step 525, the process exchanges keys with the location based device via LiFi communications (e.g., digital certificates via X.509 protocol, etc.) to authenticate the identity of the location based device. Using LiFi communications ensures that the system is proximate to the location based device and within a line of site to the device's LiFi emitters and receivers.

The process determines as to whether the key exchange successfully authenticated the identity of the location based device (decision 530). If the key exchange was successful, then decision 530 branches to the ‘yes’ branch to perform steps 550 through 580. On the other hand, if the key exchange was unsuccessful (e.g., a possible imposter posing as the location based device, etc.), then decision 530 branches to the ‘no’ branch whereupon, at step 540, the process sets the system's current geographic location identifier as “unknown” in memory area 375.

Steps 550 through 580 are performed when the identity of the location based device has been authenticated by the system through a key exchange process. At step 550, the process receives the location identifier over LiFi communications from the location based device and this location identifier is stored in memory area 560. At step 565, the process compares the location identifier received from the location based device to a list of permitted location identifiers maintained at the system and stored in memory area 370 accessible to the system (e.g., locally stored, in a network storage area, etc.). An authorized user can edit list stored in data store 370. The process determines as to whether the location identifier received from the location based device was found in the list of permitted location identifiers (decision 570).

If the location identifier was found in the list of permitted location identifiers, then decision 570 branches to the ‘yes’ branch whereupon, at step 580, the process sets the current location identifier to “listed” along with the location identifier that was received from the location based device. On the other hand, if the location identifier was not found in the list of permitted location identifiers, then decision 570 branches to the ‘no’ branch whereupon, at step 575 the process sets the current location identifier stored in memory area 375 as “unlisted” along with the location identifier that was received from the location based device.

The process determines as to whether the system is being shutdown (decision 585). If the system is being shutdown, then decision 585 branches to the ‘yes’ branch whereupon processing ends at 590. On the other hand, so long as the system is not being shutdown, then decision 585 repeatedly branches to the ‘no’ branch whereupon, at step 595, the process waits for an amount of time (e.g., one minute, etc.) before looping back to recheck the system's location and detecting any movement of the system away from the location based device.

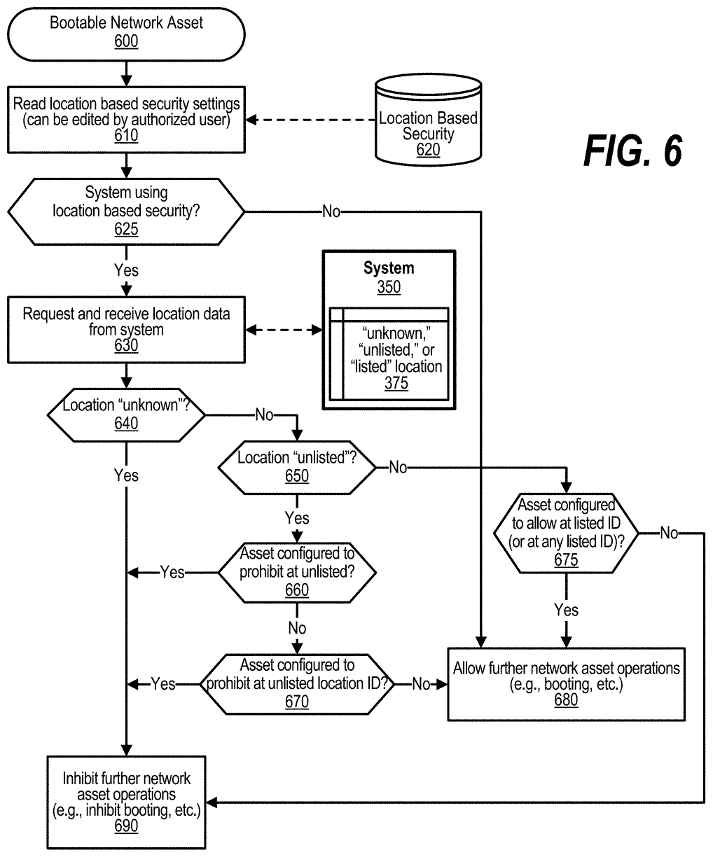

FIG. 6 is a flowchart depicting steps taken by a bootable network asset, such as physical systems, virtual machines (VMs), and application containers, to determine whether to boot based on current geographic information received from the system in which the bootable network asset is running. FIG. 6 processing commences at 600 and shows the steps taken by a process running in a bootable network asset. Examples of bootable network assets include a virtual machine (VM), an application containers, and physical information handling systems running in a system.

At step 610, the process reads the asset's location based security settings from data store 620 accessible by the asset. The security settings can be edited by an authorized user of the asset. The process determines as to whether the bootable network asset is configured to utilize location based security (decision 625). If the bootable network asset is configured to utilize location based security, then decision 625 branches to the ‘yes’ branch to perform steps 630 through 675. On the other hand, if the bootable network asset is not using location based security, then decision 625 branches to the ‘no’ branch bypassing steps 630 through 675 and further bootable network asset operations (e.g., booting the asset, etc.) are performed at step 680.

Steps 630 through 675 are performed when the asset is utilizing location based security. At step 630, the process requests and receives location data from the system in which the asset is running. The process determines as to whether the location identifier is “unknown” (decision 640). If the location identifier is “unknown”, then decision 640 branches to the ‘yes’ branch whereupon, at step 690, the process inhibits further network asset operations (e.g., inhibits booting of the asset, etc.).

On the other hand, if the location identifier is not “unknown”, then decision 640 branches to the ‘no’ branch whereupon a decision is made as to whether the location identifier is “unlisted” by the system. If the location identifier is “unlisted,” then decision 650 branches to ‘yes’ branch whereupon another decision is made as to whether the asset is configured to prohibit operations at an unlisted location (decision 660).

If the asset is configured to prohibit operations at an unlisted location, then decision 660 branches to ‘yes’ branch whereupon, at step 690, the process inhibits further network asset operations (e.g., inhibits booting of the asset, etc.). On the other hand, if the asset is configured to possibly allow operations at an “unlisted” location, then decision 660 branches to ‘no’ branch to process decision 670.

At decision 670, the process determines as to whether the asset is configured to prohibit at the particular unlisted location identifier. In one embodiment, location identifiers that are permitted when the asset is at an “unlisted” location are provided in the asset's configuration settings with all other location identifiers deemed to be prohibited. If the asset is configured to prohibit operations at the current (unlisted) location identifier, then decision 670 branches to the ‘yes’ branch whereupon, at step 690, the process inhibits further network asset operations (e.g., inhibits booting of the asset, etc.). On the other hand, if the asset is configured to allow operations at the (unlisted) location identifier, then decision 670 branches to the ‘no’ branch whereupon further bootable network asset operations (e.g., booting the asset, etc.) are performed at step 680.

Returning to decision 650, if the location identifier is “listed” then decision 650 branches to the ‘no’ branch whereupon the process determines as to whether the asset is configured to allow operations at the (listed) location identifier (decision 675). In one embodiment, all “listed” location identifiers are deemed acceptable for asset operations except for those location identifiers listed in asset configuration file 620 as being unacceptable locations. If asset configured to allow at the listed location identifier, then decision 675 branches to the ‘yes’ branch whereupon further bootable network asset operations (e.g., booting the asset, etc.) are performed at step 680. On the other hand, if the asset is configured to disallow operations at the listed location identifier, then decision 675 branches to the ‘no’ branch whereupon, at step 690, the process inhibits further network asset operations (e.g., inhibits booting of the asset, etc.).

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes a processor and a memory accessible by the processor, the method comprising:
receiving a location data from a location based device via a Light Fidelity (LiFi) wireless communication adapter, wherein a LiFi receiver in the information handling system is within a direct line-of-sight to a LiFi transmitter of the location based device; and
providing the received location data to a bootable network asset, wherein the bootable network asset determines whether to operate based on the received location data.

2. The method of claim 1 further comprising:
authenticating the location based device by receiving, at the LiFi receiver, a public key certificate from the location based device using the LiFi wireless communication adapter.

3. The method of claim 1 further comprising:
receiving an indicator included in the received location data, wherein the indicator indicates whether the location based device is currently within a previously established authorized geographic polygon.

4. The method of claim 1 further comprising:
receiving a current location identifier included in the received location data; and
comparing the received current location identifier with a set of pre-approved location identifiers, wherein the bootable network asset is further provided a result of the comparing.

5. The method of claim 1 further comprising:
setting a location status to indicate a status of the information handling system's current location, wherein the status is selected from the group consisting of unknown, unlisted, and listed; and
providing the location status to the bootable network asset.

6. The method of claim 5 further comprising:
determining whether a current location identifier was received from the location based device; and
including any received current location identifier in the location identifier that is provided to the bootable network asset.

7. The method of claim 1 further comprising:
authenticating the location based device by receiving, at the LiFi receiver, a public key certificate from the location based device using the LiFi wireless communication adapter;
in response to a successful authentication of the location based device, determining whether a current location identifier was received from the location based device;
in response to receiving the current location identifier from the location based device, comparing the received current location identifier with a set of pre-approved location identifiers, wherein the bootable network asset is further provided a result of the comparing;
setting a location status to indicate a status of the information handling system's current location, wherein the status is selected from the group consisting of unknown, unlisted, and listed; and
providing the location status to the bootable network asset.

8. An information handling system comprising:
one or more processors;
a Light Fidelity (LiFi) communications adapter;
a memory coupled to at least one of the processors; and
a set of instructions stored in the memory and executed by at least one of the processors to perform actions comprising:
receiving a location data from a location based device via a Light Fidelity (LiFi) wireless communication adapter, wherein a LiFi receiver in the information handling system is within a direct line-of-sight to a LiFi transmitter of the location based device; and
providing the received location data to a bootable network asset, wherein the bootable network asset determines whether to operate based on the received location data.

9. The information handling system of claim 8 wherein the actions further comprise:
authenticating the location based device by receiving, at the LiFi receiver, a public key certificate from the location based device using the LiFi wireless communication adapter.

10. The information handling system of claim 8 wherein the actions further comprise:
receiving an indicator included in the received location data, wherein the indicator indicates whether the location based device is currently within a previously established authorized geographic polygon.

11. The information handling system of claim 8 wherein the actions further comprise:
receiving a current location identifier included in the received location data; and
comparing the received current location identifier with a set of pre-approved location identifiers, wherein the bootable network asset is further provided a result of the comparing.

12. The information handling system of claim 8 wherein the actions further comprise:
setting a location status to indicate a status of the information handling system's current location, wherein the status is selected from the group consisting of unknown, unlisted, and listed; and
providing the location status to the bootable network asset.

13. The information handling system of claim 12 wherein the actions further comprise:
determining whether a current location identifier was received from the location based device; and
including any received current location identifier in the location identifier that is provided to the bootable network asset.

14. The information handling system of claim 8 wherein the actions further comprise:
authenticating the location based device by receiving, at the LiFi receiver, a public key certificate from the location based device using the LiFi wireless communication adapter;
in response to a successful authentication of the location based device, determining whether a current location identifier was received from the location based device;
in response to receiving the current location identifier from the location based device, comparing the received current location identifier with a set of pre-approved location identifiers, wherein the bootable network asset is further provided a result of the comparing;
setting a location status to indicate a status of the information handling system's current location, wherein the status is selected from the group consisting of unknown, unlisted, and listed; and
providing the location status to the bootable network asset.

15. A computer program product comprising:
a computer readable storage medium comprising a set of computer instructions, the computer instructions effective to perform actions comprising:
receiving a location data from a location based device via a Light Fidelity (LiFi) wireless communication adapter, wherein a LiFi receiver in the information handling system is within a direct line-of-sight to a LiFi transmitter of the location based device; and
providing the received location data to a bootable network asset, wherein the bootable network asset determines whether to operate based on the received location data.

16. The computer program product of claim 15 wherein the actions further comprise:
authenticating the location based device by receiving, at the LiFi receiver, a public key certificate from the location based device using the LiFi wireless communication adapter.

17. The computer program product of claim 15 wherein the actions further comprise:
receiving an indicator included in the received location data, wherein the indicator indicates whether the location based device is currently within a previously established authorized geographic polygon.

18. The computer program product of claim 15 wherein the actions further comprise:
receiving a current location identifier included in the received location data; and
comparing the received current location identifier with a set of pre-approved location identifiers, wherein the bootable network asset is further provided a result of the comparing.

19. The computer program product of claim 15 wherein the actions further comprise:
setting a location status to indicate a status of the information handling system's current location, wherein the status is selected from the group consisting of unknown, unlisted, and listed; and
providing the location status to the bootable network asset.

20. The computer program product of claim 19 wherein the actions further comprise:
determining whether a current location identifier was received from the location based device; and
including any received current location identifier in the location identifier that is provided to the bootable network asset.
